(19) United States
(12) Patent Application Publication
(10) Pub. No.: US 2010/0112170 A1
(43) Pub. Date: May 6, 2010

(54) EDIBLE EMULSIONS WITH PGPR

(76) Inventors: Sandra Petronella Barendse, Vlaardingen (NL); Johannes Robert Bons, Vlaardingen (NL); Eckhard Flöter, Vlaardingen (NL); Hindrik Huizinga, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/514,594

(22) PCT Filed: Nov. 8, 2007
(86) PCT No.: PCT/EP2007/062064

§ 371 Date: Jan. 7, 2010

(30) Foreign Application Priority Data
Nov. 15, 2006 (EP) 06124127.9
Nov. 24, 2006 (EP) 06124751.6
Nov. 24, 2006 (EP) 06124753.2
Nov. 24, 2006 (EP) 06124754.0
Feb. 19, 2007 (EP) 07102615.7

(51) Int. Cl. A23L 1/22

(52) U.S. Cl. 426/534

(57) ABSTRACT

Edible emulsion comprising a tasty ingredient with an undesired flavour, 0.1 to 1 wt % polyglycerol polyricinoleate and 15 to 85 wt % fat, wherein the tasty ingredient is present in an amount that gives the undesired flavour in the emulsion without the polyglycerol polyricinoleate.

### FIELD OF THE INVENTION

The invention relates to an edible emulsion comprising a tasty ingredient and polyglycerol polyricinoleate.

### BACKGROUND TO THE INVENTION

Edible emulsions are used in a variety of ways, e.g. spreadable products, frying products, baking ingredients, drinks, diary type products. They are therefore suitable vehicles for incorporation of healthy ingredients, such as blood-cholesterol lowering ingredients e.g. like sterols, blood-pressure lowering ingredients, e.g. like peptides, long-chain poly unsaturated fatty acids (LC-PUFA) from fish-oil, poly phenols, anti-oxidants and many more.

Unfortunately for a number of these healthy ingredients the taste is not appreciated, as they taste bitter or have a rancid taste. In addition, some of the healthy ingredient may by themselves have a good taste but the combination of the healthy ingredient with the food stuff it is incorporated in is not appreciated, as the taste of the healthy ingredient does not combine very well with the taste of the food product, e.g. a sweet taste in a savoury product, or it has a strong taste that overshadows the taste of the food product.

Often tasty ingredients are encapsulated to prevent the contact of the ingredient with the mouth. A drawback of the encapsulation is that a suitable encapsulate should be found that works well in the food product. Furthermore encapsulates are often more expensive than the bare ingredient itself. In addition, if the tasty ingredient has a functional effect on the food product, this effect is often lost when the ingredient is encapsulated.

Another way of masking a taste is to add another taste that overtakes the taste of the healthy ingredient. However often a lot of the masking taste should be added to mask the undesired taste and not much flexibility in taste is left, and another strong taste is left, which leaves out neutral tasting food products.

Polyglycerol polyricinoleate (PGPR) is a strong water-in-oil emulsifier and has been used in many spread and margarine applications and is commonly used for chocolate compositions. Examples are WO 03/51135, WO 01/91570, EP 0997074, and WO 02/49443 however in none of the applications the use of a tasty ingredient with an undesired taste is disclosed. EP 0997074 even discloses that emulsions without PGPR taste better than emulsions with PGPR.

WO 03/049548 discloses water-continuous emulsified food compositions comprising water-soluble tastants. The compositions of WO 03/049548 are W1/O/W2 duplex emulsions wherein water phases W1 (dispersed water phase) and W2 (continuous water phase) comprise at least one water-soluble tastant in both of the water phases and are substantially isotonic for the tastant. These duplex emulsions give a reduced taste impression of the tastant when compared to single water-continuous emulsions. Unfortunately duplex emulsions are inherently more complex than single emulsions. Furthermore at least 2 waterphases need to be prepared each containing the tastant and being isotonic for the tastant. In addition, only water-continuous emulsions are disclosed. The internal emulsion (W1/O) is stabilised by an emulsifier with hydrophobic lipophilic balance (HLB) of less than or equal to 6. An example of such an emulsifier is polyglycerol polyricinoleate.

WO 02/089594 discloses all vegetable emulsions wherein the aqueous phase comprises a protein containing cereal base and the fat phase comprises a fractionated vegetable oil. The examples show comparative spreads with polyglycerol polyricinoleate (PGPR). The spreads were tested by a taste panel. The results show that spreads with fractionated oat oil have better taste feel for salt and sourness in comparison with spread without oat oil but with PGPR. There is however no difference tasted in spreads for rancid, old, metallic and bitterness taste. Furthermore spreads with PGPR and with oat base had a more salty taste than spread without PGPR and without oat base and the same sourness taste for both.

US2003/0108591 discloses ingestable products for lowering blood total cholesterol including isoflavone, soy protein and phytosterol. Spreads are mentioned as a beneficial form for ingestion. Furthermore, polyglycerol polyricinoleate is described as an advantageous emulsifier. There is no disclosure of an undesirable taste.

EP 1 618 800 discloses composition with extracts of tomatoes and physiological active fatty acids, their salts or their esters. From a very long list of possible additives, emulsifiers are described. The list of emulsifiers is very extensive and mentions amongst many other emulsifiers polyglycerol polyricinoleate. One example describes an emulsion. This emulsion is water-continuous, yoghurt from soy milk, and does not use polyglycerol polyricinoleate. The flavour of the yoghurt with tomato-extract and conjugated linoleic acid is said to be substantially undistinguishable from corresponding yoghurt composition using 100 percent of fresh cow milk.

U.S. Pat. No. 6,159,526 discloses chocolate compositions being a water-in-oil chocolate with strawberry or banana puree and polyglycerol polyricinoleate. The taste was said to be delicious.

In WO 00/64276 discloses water-in-oil spreads including phytoestrogens and calcium salts. The spreads have good taste despite the presence of often-bitter tasting isoflavones. Polyglycerol polyricinoleate is said an optional ingredient. No examples are disclosed containing polyglycerol polyricinoleate.

WO 00/64268 discloses water in oil emulsions with a variegate composition having a pronounced sweet taste. The variegate composition can be based on vegetable extracts or fruit extracts. In example 1 a water-in-oil composition is made with strawberry puree. However the strawberry puree is a normal fruit puree and thus has a well appreciated taste. Furthermore another emulsifier than polyglycerol polyricinoleate is used.

WO 2005/004642 discloses fat continuous low fat products with polyglycerol polyricinoleate and potassium sorbate. However the level of potassium sorbate of 0.05% and 0.1% (i.e. 0.013% and 0.026% of potassium ion) is so low that the bitter taste of the potassium is not tasted in an emulsion without polyglycerol polyricinoleate.

WO 2006/037847 discloses emulsified food products comprising water and 0 to 5 wt % of triglycerides, 0.5 to 60 wt % of plant sterol and/or stanol fatty esters, and optionally one or more emulsifiers. A low energy spread is disclosed with 0.2 wt % of polyglycerol polyricinoleate and an unknown amount of potassium sorbate, however the spread does not contain fat.

It is therefore an object of the current invention to provide a food product which comprises a tasty ingredient. In addition, it is an object of the present invention to provide a food product which comprises a healthy ingredient with an undesired taste wherein the undesired taste of the ingredient is not noticed by consumers. Furthermore an object of the invention is to provide a food product with a tasty ingredient wherein the undesired taste is not noticed by consumers but still has the same functionality as the food product with the health ingredient if the taste has not been masked. Another object of the invention is to provide a food product which is stable under storage at ambient and higher temperatures. Further food products with good organoleptic properties are envisioned with the current invention.

### SUMMARY OF THE INVENTION

One or more of the above objects are attained by an edible emulsion comprising a tasty ingredient with an undesired flavour, 0.1 to 1 wt % polyglycerol polyricinoleate and 15 to 85 wt % fat, wherein the tasty ingredient is present in an amount that gives the undesired flavour in the emulsion without the polyglycerol polyricinoleate.

It was surprisingly found that emulsions with a tasty ingredient do not have the flavour of the tasty ingredient itself if polyglycerol polyricinoleate (PGPR) is used in the emulsion.

### DETAILED DESCRIPTION OF THE INVENTION

The present invention relates to a tasty ingredient with an undesired flavour. Flavour is the sensory impression of a food or other substance, and is determined mainly by the chemical senses of taste and smell. It may be ingredients that have a bitter taste, rancid taste, off-flavour taste, metallic taste, or old taste, offensive taste. It may also be ingredients that have a very pronounced taste or flavour which is undesired for the specific type of food product. Examples are salt flavour for sweet products, or sweet flavour for savoury type products, coffee flavoured ingredients for spreads to be used as margarine. The flavour of the tasty ingredient may be determined by a sensory panel.

The taste or flavour of an ingredient is dependent on the concentration of the ingredient. Therefore the present invention relates to an emulsion with a tasty material in an amount that gives the undesired flavour in the emulsion without polyglycerol polyricinoleate. The tasty material is tested by a sensory panel that evaluates the tasty material in an emulsion with and without polyglycerol polyricinoleate. Tasty materials that show a different in taste or flavour between emulsions with and without polyglycerol polyricinoleate are envisioned by the present invention.

Sensory panels consist of trained human assessors that qualify and quantify sensory properties of foods. The responses made by the sensory panels are recorded and may be analysed by statistical methods e.g. ANOVA, multivariate or univariate data analyses. Within food research, sensory panels are commonly used to qualify and quantify sensory properties, such as taste, odour or smell, flavour, mouthfeel, and other organoleptic properties. The type of sensory panel will depend on the taste of the tasty ingredient and the product format, however these consideration are all within the skills of a skilled person.

Preferably the edible emulsion of the present invention has a good melting behaviour. Melting behaviour influences the organoleptic properties of an emulsion. If the emulsion doesn't melt fast enough a waxy mouthfeel becomes present and this is not appreciated by consumers.

In addition, suitably the edible emulsion of the present invention has overall a good taste impression, suitable for the product, despite the presence of a tasty ingredient with an undesired flavour. The emulsion preferably has a good melting behaviour in the mouth and a creamy and/or dairy taste is appreciated.

For the present invention healthy ingredients are ingredients that provide a health benefit to a food. Many healthy ingredients have an undesired flavour. The present invention is therefore especially suited for tasty ingredients that are also healthy ingredients. Examples are potassium salts and peptides that have a blood pressure lowering effect. It is known that potassium salt in the amount needed to obtain a health benefit gives a strong bitter taste to a food product. Many healthy ingredients need a certain doses in order to give a health benefit, the so-called effective amount. Often these effective amounts are high thereby increasing the undesired taste to the food product they are in. The present invention is specifically suited for healthy ingredients in effective amounts.

Preferably the effective amount of the healthy ingredient is such that it would give a health benefit in a daily serving size of the food product. The daily serving size is the amount of a food product typically eaten in a day. The daily serving size need not to be taken in 1 go, i.e. it may be divided up in several portions a day. Different food products have different daily serving sizes. Margarine for example has a daily serving size of about 10 to 30 g per day, which may be divided up in 4 portions, together giving the daily serving size.

In a suitable embodiment of the present invention, the healthy ingredient provides a health effect. Preferably the health effect is selected from the group comprising reduction of risk for cardiovascular disease, reduction of blood pressure, reduction of blood cholesterol, increased resistance to disease, improved immune response, improved brain function, weight loss, weight control, reduction of Body Mass Index (BMI), improved blood flow, lowering plasma triglycerides, anti-inflammatory effect, antirheumatic effect, smooth platelets, inhibition of platelet aggregation, antithrombotic effect and healthy growth for children.

Preferably the tasty ingredient is selected from the group comprising peptides, hydrolysed milk proteins, potassium salt, mineral salts, aqueous fruit extracts, protein and fat free tomato extracts, polyphenols, such as flavonoids and flavanols, soy ingredients, green tea extracts, grape seed extracts, hawthorne, catechins, and strong anti-oxidants. It should be noted that e.g. milk proteins that are not hydrolysed have a very pleasant taste, in contrast to hydrolysed milk proteins and peptides that have a very bitter taste. Also tomatoes and fruit by themselves and their purees may have a nice taste which is appreciated by consumers. In contrast aqueous extracts from fruit and tomato being substantially free of insoluble matter such as fruitflow do not have a pleasant taste, especially in an effective amount. The present invention is therefore especially suited for tasty ingredients with an undesired flavour. The undesired flavour may be selected from the group of bitterness, rancid, old, metal, cardboard, oxidized, musty, dusty and astringent. Whereas positive flavours are preferably retained. Positive flavours may be selected from dairy, buttermilk, sweet, candy, caramel, cream. Whether a flavour is perceived as positive or undesired may depend on the product format.

The invention is especially suited for bitter tasting compounds. Suitably the healthy ingredient is water soluble.

The amount of healthy ingredient depends on the effective amount and on the daily serving size of the edible emulsion and can be determined by the skilled person. Preferably, the amount is 50 to 500% of the recommended daily intake (RDI) of the healthy ingredient per daily serving size, more preferably 100 to 250%, most preferably 100 to 150% of the RDI. Preferably the daily serving size is divided into 2 to 4 portions a day.

The present invention is especially suitable for non-encapsulated tasty ingredints. The use of polyglycerol polyricinoleate in the edible emulsion of the present invention circumvents the need for encapsulation of tasty ingredients with an undesired flavour. A preferred embodiment of the present invention provides for an edible emulsion with a tasty ingredient with an undesired flavour that is not encapsulated.

The present invention is also very suitable for edible emulsions with more than 1 tasty ingredient. Even though a taste or flavour of an ingredient might be acceptable to a food product, the addition of another tasting ingredient might give a combination of flavours that is not desired, e.g. a chocolate flavour with an onion flavour. Because the edible emulsion with polyglycerol polyricinoleate somehow masks the taste of the tasty ingredient, 2 or more tasty ingredients with different taste would still give a food product with an acceptable taste when applying the present invention. A preferred embodiment of the present invention provides for an edible emulsion with more than 1 tasty ingredient. Even more preferred the present invention provides for an edible emulsion with more than 1 tasty ingredient wherein at least 1 tasty ingredient gives a health benefit.

Another suitable embodiment of the present invention is an emulsion with a neutral taste. The present invention avoids the need of the addition of another flavour to mask the taste, thereby providing an ability to have neutral tasting products. The neutral taste of a food product may be assessed by a sensory panel.

Products according to the invention comprise polyglycerol polyricinoleate which is commercially available amongst others under the name PGPR 90 ex Danisco, and under the name of Admul WOL ex Kerry. This ingredient is generally known to be excellent water-in-oil emulsifier.

The amount of polyglycerol polyricinoleate in the products of the invention is from 0.1 to 1% wt % on total product weight. Higher amounts lead to products which do not easily de-emulsify in the mouth upon consumption and will hence not show the desired organoleptic properties. Preferably the amount of polyglycerol polyricinoleate in food products according to the invention is from 0.2 to 0.4 wt %.

The emulsion of the invention may comprise thickeners. For stability reasons it may be useful to include thickeners in the emulsion, for example very low spreads, with 20 to 30 wt % of fat, often improve by addition of thickeners. Whether or not a thickener should be added and in what amount depends on factors as stability and application and may be determined by the skilled person.

Thickener may be any known thickener and are preferably selected from the group comprising gums, like xanthan, guar, and locust bean, carrageenan, polysaccharides, alginate, pectin, starch, modified starch and gelatine.

In preferred food products according to the invention, the aqueous phase comprises a native or a modified fully gelatinised starch which may be cook-up or pre-gelled, selected from any of the main starch groups: wheat, potato, rice, maize, waxy rice or waxy maize.

Examples of suitable starches include Remyrice™, Resistamyl™, Merigel™, Purity LFS™

The amount of starch in the food product according to the invention depends somewhat on the type of chosen starch and is preferably from 0.2 to 5 wt %, more preferred from 0.7 to 3 wt %, most preferred from 1 to 2 wt %.

In a preferred embodiment the emulsion is fat continuous. In another preferred embodiment the emulsion is not a duplex emulsion. Even more preferred the emulsion is a single emulsion. A preferred embodiment of the present invention is a spread. Preferably the emulsion of the present invention is not chocolate or a chocolate containing emulsion.

The emulsion according to the invention comprises from 15 to 85 wt % of a fat, preferably from 20 to 70 wt % more preferably from 25 to 60 wt %, most preferably from 30 to 40 wt % fat. The fat consists predominantly of triglycerides. The fat can be a single fat or a combination of fats.

The fat or fat blend may comprise vegetable or animal fats which may be hydrogenated, interesterified or fractionated and combinations thereof. Suitable animal fats may consist of butterfat or tallow. Suitable vegetable fats can for example be selected from the group comprising bean oil, sunflower oil, palm kernel oil, coconut oil, palm oil, rapeseed oil, cotton seed oil, maize oil, or their fractions, or a combination thereof. Interesterified fat blends of these fats or optionally with other fats are also encompassed in the invention.

Advantageously, long chain poly unsaturated fatty acids (LC-PUFA), e.g. omega-3 and omega-6 fatty acids are incorporated in the edible emulsion of the present invention. Suitably these LC-PUFAs come from sources like fish oil and/or algae oil.

To ensure homogeneous distribution of the aqueous phase in the continuous fat phase, the droplet size distribution D_{3,3} of the dispersed aqueous phase is preferably less than 8 μm, more preferably from 4 to 8 μm, more preferred even lower than 4 μm. The method to determine D_{3,3} is illustrated in the examples. It will be appreciated that the droplet size can be controlled by adjusting the processing conditions in the unit operations: e.g. higher rotational speed in a scraped surface heat exchanger will produce correspondingly smaller water droplet size distributions.

In addition to the water-in-oil emulsifier polyglycerol polyricinoleate, the food product according to the invention comprises another emulsifier, the co-emulsifier. This co-emulsifier is preferably also a water-in-oil emulsifier. More preferably this co-emulsifier is selected from the group comprising distilled monoglycerides, citric acid esters of monoglycerides, di-acetyl acetic acid esters of monoglycerides, lactic acid esters of monoglyceride, mono-diglycerides, polyglycerol esters of fatty acids or sorbitan esters of fatty acids.

The most preferred co-emulsifier is a distilled monoglyceride. Even more preferred are monoglycerides with unsaturated fatty acids or combinations of a monoglyceride comprising a saturated fatty acid residue and a monoglyceride comprising an unsaturated fatty acid residue.

The amount of co-emulsifier depends on the type and effectiveness of the emulsifier selected and can be determined by the person skilled in the art. Other factors influencing the amount of emulsifier that is required to obtain storage stable products are the amount of fat and the amount of polyglycerol polyricinoleate.

As a general guidance the amount of emulsifier is preferably from 0.05 to 1.5 wt %, more preferred from 0.1 to 0.7 wt %, most preferred from 0.15 to 0.5 wt %.

The pH of the aqueous phase can be set to the desired value, among others to influence acidic or basic taste impression and to influence microbial stability. Preferably the pH of the aqueous phase in food products according to the invention is from 4.3 to 5.5.

Optionally some protein is added to the product according to the invention. Protein may be added to beneficially influence the taste, flavour and nutritional value of the food product and also may be added to increase browning of food stuff when the current composition is used as a medium for shallow frying. Preferably the protein source is selected from the group comprising milk powders such as skim milk powder, butter milk powder, sodium caseinate, sour whey, denatured whey, or a combination thereof. It should be noted that normal, unhydrolysed dairy protein, is not encompassed in the definition of tasty ingredient with an undesired flavour.

Preferably at least 0.3 wt % of protein is present in the emulsion, more preferably from 0.3 to 1 wt %. In a preferred embodiment the emulsion according to the invention does not comprise a protein containing oat base such that the protein content of the emulsion is 0.01-0.2% by weight. In another preferred embodiment the emulsion is not a water-in-oil spread comprising isoflavones, soy protein, and phytosterols.

The emulsion according to the invention optionally contain other ingredients such as preservatives, vitamins, taste and flavour components, colorants such as beta-carotene, anti-oxidants.

The emulsion according to the invention can be prepared by any suitable process to prepare such products. For fat continuous emulsions, a preferred process is a so-called inversion process; a fat phase containing polyglycerol polyricinoleate and a waterphase are provided and mixed to obtain a water-continuous pre-mix containing the tasty ingredient with the undesired flavour. The water-continuous premix is later inverted to a fat-continuous emulsion.

In some cases to obtain a health effect, the effective amount of the tasty ingredient is large such that a fat-continuous mix of all the ingredients is too thick and the pressure in the system is too high. It was surprisingly found that first a water-continuous premix could be made that did not have the high pressure issues. Polyglycerol polyricinoleate is a very strong water-in-oil emulsifier (HLB ˜1) and it was not expected that a water-continuous premix would not have the pressure problems.

Preferably the emulsion is a food product.

### EXPERIMENTAL

### Storage Stability Test

Food product was stored in a plastic container at 10, 20, 30, 35 and 40° C. for up to 26 weeks. After storage the amount of phase separation was determined by visual examination of the product surface. Storage stable products show a phase separation of less than 5 wt % upon storage at 35° C. for at least 10 weeks, preferably at least 26 weeks. Preferably the phase separation is less than 5 wt % upon storage at 40° C.

### D3,3 Value Measurements and E-Sigma:

Samples were filled to a height of 15 mm in NMR tubes of 10 mm diameter, and thermally equilibrated for 30 min at 20° C. A restricted diffusion-based droplet size was obtained by means of pfg-NMR using a Bruker Minispec MQ20. The details of the technique are discussed by Goudappel et al (Journal of Colloid and Interface Science 239, (2001) 535-542). A measurement yields values for the volume weighted geometric mean diameter d_{3,3} and the width of, the droplet size distribution when plotted as a function of the logarithm of the diameter σ (E-sigma). Measurements were carried out in triplicate and results are expressed in terms of average d_{3,3} values. Definitions of droplet sizes are given by Alderliesten (Particle and Particle Systems Characterization 7 (1990) 233-241, and ibid 8 (1991) 237-241).

### Example 1-4 and Comparative Example A-B

Ingredients are listed in table 1

TABLE 1
ingredients in wt %

| Ingredient | Ex 1 | Ex 2 | Ex 3 | Ex 4 | Comp A | Comp B |
|---|---|---|---|---|---|---|
| fat | 28.6 | 28.6 | 28.6 | 28.6 | 29 | 29 |
| Plant sterols | 12.7 | 12.7 | 12.7 | 12.7 | 12.7 | 12.7 |
| Fish oil | 0.7 | 0.7 | 0.7 | 0.7 | 0.7 | 0.7 |
| concentrate | | | | | | |
| PGPR | 0.4 | 0.4 | 0.4 | 0.4 | 0 | 0 |
| Dimodan HP | 0.2 | 0.2 | 0.2 | 0.2 | 0.2 | 0.2 |
| Beta carotene | 0.1 | 0.1 | 0.1 | 0.1 | 0.1 | 0.1 |
| synthetic | | | | | | |
| flavour | 0.3 | 0.3 | 0.3 | 0.3 | 0.3 | 0.3 |
| Sunlec Z | 0.1 | 0.1 | 0.1 | 0.1 | 0.1 | 0.1 |
| Potassium gluconate | 10 | 5 | 12.5 | 12.5 | 10 | 5 |
| Potassium lactate | 0 | 0 | 0 | 0 | 0 | 4.6 |
| Potassium chloride | 0 | 1.6 | 0 | 0 | 0 | 0 |
| Potassium sorbate | 0.26 | 0.26 | 0.26 | 0.26 | 0.26 | 0.26 |
| BMP | 0.2 | 0.2 | 0.2 | 0.2 | 0.2 | 0.2 |
| Tomato extract | 0 | 0 | 0 | 0.4 | 0 | 0 |
| sucralose | 0.003 | 0.003 | 0 | 0 | 0.003 | 0.003 |
| Acesulfame-K | 0.002 | 0.002 | 0 | 0 | 0.002 | 0.002 |
| Tapioca starch | 2.75 | 2.75 | 2.75 | 2.75 | 2.75 | 2.75 |
| Water | Up to 100 | Up to 100 | Up to 100 | Up to 100 | Up to 100 | Up to 100 |
| pH | 4.5 | 4.7 | 4.5 | 4.5 | 5.0 | 5.0 |
| % K⁺ | 1.6 | 1.6 | 2.0 | 2.0 | 1.6 | 2.2 |
| Taste score | 1-2 | 2 | 1-2 | 1-2 | 5 | 4 |
| D3.3/e-sigma | 3.9/1.9 | 4.2/2.2 | 3.8/2.0 | 3.5/1.9 | 5.5/2.8 | 5.2/2.3 |

### Processing

In a vessel a mixture was prepared of the fat, monoglyceride, PGPR, antioxidant, and colorant at a temperature of about 60° C. In another, separate vessel a mixture was made of starch and water which was heated to a temperature of 92° C. for 25 minutes. This mixture was cooled to 60° C. and completed with all the other water soluble ingredients, such as salt, protein, etc. and subsequently mixed with the oil phase in a pre-mix tank at 60° C. as a water-continuous emulsion, followed by cooling and shearing in a series of A- and C-Units™ where the dimensions and energy requirements are suitable to deliver a fat-continuous end product and achieve a plastic structure which could be easily packed at around 10° C. in a suitable packaging material.

Taste scores were determined by a test panel of 10 persons; scores were given at a scale of 1-5.

1 indicates a good tasting score
3 is not acceptable for a consumer ready spread
5 is regarded as very bitter and a fully unacceptable product to offer to consumers

1. Edible emulsion comprising a tasty ingredient with an undesired flavour, 0.1 to 1 wt % polyglycerol polyricinoleate and 15 to 85 wt % fat, wherein the tasty ingredient is present in an amount that gives the undesired flavour in the emulsion without the polyglycerol polyricinoleate.

2. Edible emulsion according to claim 1 wherein the amount of polyglycerol polyricinoleate is from 0.2 to 0.4 wt %.

3. Edible emulsion according to claim 1 wherein the tasty ingredient is a healthy ingredient.

4. Edible emulsion according to claim 3 wherein the healthy ingredient is present in an effective amount.

5. Edible emulsion according to claim 1 wherein the tasty ingredient is selected from the group comprising of peptides, hydrolysed milk proteins, potassium salt, protein and fat free tomato extracts, and polyphenols.

6. Edible emulsion according to claim 1 wherein the undesired flavour is selected from the group of bitterness, rancid, old, metal, cardboard, oxidized, musty, dusty and astringent.

7. Edible emulsion according to claim 1 wherein the tasty ingredient is water soluble.

8. Edible emulsion according to claim 1 wherein the emulsion is fat continuous having a dispersed aqueous phase.

9. Edible emulsion according to claim 1 wherein the amount of fat is between 20 and 70 wt % and wherein the emulsion is a spread.

10. Edible emulsion according to claim 1 wherein the amount of fat is from 25 to 60 wt %, preferably from 30 to 40 wt %.

11. Edible emulsion according to claim 8 wherein the droplet size distribution D3,3 of the dispersed aqueous phase is less than 20 μm, preferably less than 8 μm, more preferably less than 4 μm.

12. Edible emulsion according to claim 1 also comprising a sweetner.

13. Use of 0.1 to 1 wt % polyglycerol polyricinoleate in an edible emulsion comprising 15 to 85 wt % fat and a tasty ingredient with an undesired flavour to mask the undesired flavour.

14. Use of polyglycerol polyricinoleate in an emulsion according to claim 1 to mask the undesired flavour of the tasty ingredient.
